(19) United States
(12) Patent Application Publication
(10) Pub. No.: US 2012/0196067 A1
(43) Pub. Date: Aug. 2, 2012

(54) CURED FLUOROELASTOMER HOT AIR HOSE

(75) Inventors: Tsuyoshi Kawai, Tochigi (JP); Makio Mori, Kanagawa (JP); Shuichi Okutsu, Kanagawa (JP)

(73) Assignee: E.I. DU PONT DE NEMOURS AND COMPANY, Wilmington, DE (US)

(21) Appl. No.: 13/198,169

(22) Filed: Aug. 4, 2011

Related U.S. Application Data
(60) Provisional application No. 61/376,700, filed on Aug. 25, 2010.

(51) Int. Cl. B32B 1/08

(52) U.S. Cl. 428/36.6

(57) ABSTRACT

A cured fluoroelastomer hot air hose comprises A) fluoroelastomer having at least 53 wt. % fluorine, and B) 10 to 30 parts by weight, per hundred parts by weight fluoroelastomer, of carbon black a nitrogen adsorption specific surface area of 70-150 m²/g and a dibutyl phthalate absorption of 90-180 ml/100 g.

### CROSS-REFERENCE TO RELATED APPLICATIONS

This application claims the benefit of U.S. Provisional Application No. 61/376,700 filed Aug. 25, 2010.

### FIELD OF THE INVENTION

This invention pertains to a cured fluoroelastomer hot air hose comprising fluoroelastomer and 10 to 30 parts by weight, per hundred parts by weight fluoroelastomer, of carbon black having a nitrogen adsorption specific surface area (N2SA) of 70-150 m²/g and a dibutyl phthalate (DBP) absorption of 90-180 ml/100 g.

### BACKGROUND OF THE INVENTION

Due to tightening emission regulations, the proportion of vehicles having turbocharged engines is increasing. Also the temperature to which air ducts are exposed in turbocharged engines is increasing. Fluoroelastomer is typically employed for high temperature air ducts.

Production of such fluoroelastomers by emulsion polymerization methods is well known in the art; see for example U.S. Pat. Nos. 4,214,060 and 3,876,654.

Turbocharger hose is subject to repetitive vibration at high temperature during operation. Therefore, the rubber employed in the hose should have sufficient resistance to dynamic fatigue and high temperature. Dynamic fatigue performance is typically estimated by the elongation at break (Eb) at both room temperature and at high temperature. The larger the Eb, the better the fatigue resistance. Eb tends to decrease during static heat aging. Thus, a high initial Eb at room temperature is advantageous in order to ensure adequate performance at high temperatures.

Rubber to be employed in a turbocharger hose that will be exposed to a 200° C. environment should have an Eb of at least 150% at 200° C. and at least 250% at 150° C. Such rubber should have an initial Eb at room temperature of at least 350%.

It is possible to make a rubber having an initial Eb at room temperature of at least 350% by employing a relatively low crosslink density and relatively low filler reinforcement. However, it is difficult to obtain the necessary Eb at elevated temperatures by conventional means. Physical properties of rubber at high temperatures are usually governed by a component of internal energy (i.e. energy elasticity), rather than entropy elasticity. Internal energy is mostly attributable to the filler component. Carbon black is the typical reinforcing filler employed in rubber formulations. Relatively low surface area carbon black (e.g. MT, N-990) is typically used in fluoroelastomer formulations and the reinforcement effect is typically low. This results in poor Eb performance at high temperatures for fluoroelastomer compounds.

It has been difficult to obtain any advantage from the use of high surface area carbon black in fluoroelastomer compounds because filler-gel, which is essential to generate a firm internal energy (i.e. energy elasticity) in the rubber network matrix, cannot be obtained by low shear rate mixing on a roll mill mixer typically employed for mixing carbon black into fluoroelastomer. It is possible to form filler-gel with high surface area carbon black by applying high shear rate mixing (e.g. in an internal mixer such as a Banbury® or Kneader). However, there has been a problem incorporating carbon black into fluoroelastomer with an internal mixer.

Fluoroelastomers are generally cured (i.e. crosslinked) by either a polyhydroxy compound (e.g. bisphenol AF) or by the combination of an organic peroxide and a multifunctional coagent (e.g. triallyl isocyanurate). Typically at least 2 parts by weight, per hundred parts by weight fluoroelastomer, of polyhydroxy compound or multifunctional coagent is employed in order to achieve the proper balance of physical properties if low surface area carbon black (e.g. N-990) is employed as filler.

### SUMMARY OF THE INVENTION

Surprisingly, it has been found that certain highly reinforcing carbon black fillers provide superior properties to fluoroelastomers. One aspect of the present invention provides a cured fluoroelastomer hot air hose comprising:

(A) fluoroelastomer having at least 53 weight percent fluorine, said fluoroelastomer comprising copolymerized units of vinylidene fluoride and at least one copolymerizable monomer;

(B) 10 to 30 parts by weight, per hundred parts by weight fluoroelastomer, of carbon black having a nitrogen adsorption specific surface area of 70-150 m²/g and a dibutyl phthalate absorption of 90-180 ml/100 g;

(C) 0.8 to 1.8 parts by weight, per hundred parts by weight fluoroelastomer, of a polyol curative; and

(D) 0.2 to 1 parts by weight, per hundred parts by weight fluoroelastomer, of a cure accelerator.

Another aspect of the present invention is a cured fluoroelastomer hot air hose comprising:

(A) fluoroelastomer having at least 53 weight percent fluorine, said fluoroelastomer comprising copolymerized units of vinylidene fluoride and at least one copolymerizable monomer;

(B) 10 to 30 parts by weight, per hundred parts by weight fluoroelastomer, of carbon black having a nitrogen adsorption specific surface area of 70-150 m²/g and a dibutyl phthalate absorption of 90-180 ml/100 g;

(C) 0.25 to 2 parts by weight, per hundred parts by weight fluoroelastomer, of organic peroxide; and

(D) 0.3 to 1.3 parts by weight, per hundred parts by weight fluoroelastomer, of a multifunctional coagent.

### DETAILED DESCRIPTION OF THE INVENTION

The present invention is directed to a cured (i.e. crosslinked) fluoroelastomer hot air hose. By “fluoroelastomer” is meant an amorphous elastomeric fluoropolymer. The fluoropolymer contains at least 53 percent by weight fluorine, preferably at least 64 wt. % fluorine. Fluoroelastomers that may be employed in the process of this invention contain between 25 to 70 weight percent, based on the weight of the fluoroelastomer, of copolymerized units of vinylidene fluoride (VF₂). The remaining units in the fluoroelastomers are comprised of one or more additional copolymerized monomers, different from said VF₂, selected from the group consisting of fluorine-containing olefins, fluorine-containing vinyl ethers, hydrocarbon olefins and mixtures thereof.

Fluorine-containing olefins copolymerizable with the VF₂ include, but are not limited to, hexafluoropropylene (HFP), tetrafluoroethylene (TFE), 1,2,3,3,3-pentafluoropropene (1-HPFP), chlorotrifluoroethylene (CTFE) and vinyl fluoride.

Fluorine-containing vinyl ethers copolymerizable with VF₂ include, but are not limited to perfluoro(alkyl vinyl)ethers. Perfluoro(alkyl vinyl) ethers (PAVE) suitable for use as monomers include those of the formula

CF₂═CFO(R_{f}.O)ₙ(R_{f}.O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl)ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl)ethers includes those ethers wherein n is 0 or 1 and R_{f} contains 1-3 carbon atoms. Examples of such perfluorinated ethers include perfluoro(methyl vinyl)ether (PMVE) and perfluoro(propyl vinyl)ether (PPVE). Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z═F or CF₃. Preferred members of this class are those in which R_{f} is C₃F₇, m=0, and n=1.

Additional perfluoro(alkyl vinyl)ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5.
Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers employed in this invention, the PAVE content generally ranges from 25 to 75 weight percent, based on the total weight of the fluoroelastomer. If perfluoro(methyl vinyl)ether is used, then the fluoroelastomer preferably contains between 30 and 55 wt. % copolymerized PMVE units.

The fluoroelastomers employed in the cured article of the present invention may also, optionally, comprise units of one or more cure site monomers. Examples of suitable cure site monomers include: i) bromine-containing olefins; ii) iodine-containing olefins; iii) bromine-containing vinyl ethers; iv) iodine-containing vinyl ethers; v) 1,1,3,3,3-pentafluoropropene (2-HPFP); viii) perfluoro(2-phenoxypropyl vinyl)ether; and vi) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂(R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1(ITFB); 3-chloro-4-iodo-3,4,4-trifluorobutene; 2-iodo -1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent 2,067,891 and European Patent 0784064A1. A suitable triene is 8-methyl-4-ethylidene-1,7-octadiene.

Of the cure site monomers listed above, preferred compounds, for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; and bromotrifluoroethylene. When the fluoroelastomer will be cured with a polyol, 2-HPFP is the preferred cure site monomer. However, a cure site monomer is not required in copolymers of vinylidene fluoride and hexafluoropropylene in order to cure with a polyol.

Units of cure site monomer, when present in the fluoroelastomers employed in the cured article of this invention, are typically present at a level of 0.05-10 wt. % (based on the total weight of fluoroelastomer), preferably 0.05-5 wt. % and most preferably between 0.05 and 3 wt. %.

The level of curative employed to crosslink the fluoroelastomer compositions employed in this invention is set to balance properties such as elongation at break and tensile strength. The lower the level of curative, the higher the elongation at break.

Additionally, iodine-containing endgroups, bromine-containing endgroups or mixtures thereof may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed in European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use in the fluoroelastomers employed in this invention include those disclosed in U.S. Pat. No. 3,707,529. Examples of such agents include isopropanol, diethylmalonate, ethyl acetate, carbon tetrachloride, acetone and dodecyl mercaptan.

Specific fluoroelastomers which may be employed in the cured article of this invention include, but are not limited to those having at least 53 wt. % fluorine and comprising copolymerized units of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl)ether, tetrafluoroethylene and 4-bromo-3,3,4,4-tetrafluorobutene-1; vi) vinylidene fluoride, perfluoro(methyl vinyl)ether, tetrafluoroethylene and 4-iodo-3,3,4,4-tetrafluorobutene-1; and vii) vinylidene fluoride, perfluoro(methyl vinyl)ether, tetrafluoroethylene and 1,1,3,3,3-pentafluoropropene.

Fluoroelastomers that may be employed in the cured article of this invention are typically made in an emulsion polymerization process and may be a continuous, semi-batch or batch process.

The carbon black filler employed in this invention is a highly reinforcing, high structure black having a nitrogen adsorption specific surface area (ASTM D-6556) of 70-150 (preferably 80-120) m²/g and a dibutylphthalate absorption (ASTM D-2414) of 90-180 (preferably 100-130) ml/100 g. Examples of such types of carbon black include, but are not limited to HAF (ASTM N330), ISAF (ASTM N220) and SAF (ASTM N110). HAF is preferred. Mixtures of various carbon blacks may be employed.

The amount of carbon black employed in the cured articles of this invention is 10 to 30 (preferably 15 to 20) parts by weight per hundred parts by weight fluoroelastomer.

Fluoroelastomer and the selected highly reinforcing carbon black are combined in an internal mixer (e.g. Banbury®, Kneader or Intermix®). Internal mixers lack sufficient shear deformation in their inherent design to incorporate fine filler pigment with low fluidity fluoroelastomer polymer. However, it has been discovered that the low shear deformation may be compensated for by premixing the fluoroelastomer polymer alone in an internal mixer until the polymer temperature reaches at least 90° C. (preferably at least 100° C.). The highly reinforcing carbon black can then be added to the hot fluoroelastomer polymer. The formation of firm filler gel may be achieved by application of high shear rate and high temperature. For the proper formation of firm filler gel, the maximum mixing temperature is between 150° C. and 180° C., preferably between 155° C. and 170° C. The mixer rotor is set between 20 and 80 (preferably 30-60) revolutions per minute (rpm) so that the average shear rate is 500-2500 (preferably 1000-2000) s⁻¹.

When a peroxide curing system is employed to crosslink the articles of this invention, the level of multifunctional coagent (e.g. triallyl isocyanurate) is 0.3-1.3, preferably 0.5-1.0, parts by weight, per hundred parts by weight fluoroelastomer. The level of peroxide is 0.25-2, preferably 0.7-1.5, parts by weight, per hundred parts by weight fluoroelastomer.

When a polyol compound (e.g. bisphenol AF) is employed to crosslink the articles of this invention, the curative level is 0.8-1.8, preferably 1.0-1.5, parts by weight per hundred parts by weight fluoroelastomer. The level of accelerator (e.g. a quaternary ammonium or phosphonium salt) is typically 0.2-1.0, preferably 0.4-0.8, parts by weight, per hundred parts by weight fluoroelastomer.

Curative is added to the fluoroelastomer and carbon black mixture at a temperature below 120° C. in order to prevent premature vulcanization. The compound is then shaped and cured in order to manufacture the cured hot air hose of the invention.

Optionally, the cured hot air hoses of the invention may contain further ingredients commonly employed in the rubber industry such as process aids, colorants, acid acceptors, etc.

Cured (i.e. crosslinked) hot air hoses of this invention (e.g. turbocharger hoses) have a remarkable balance of heat resistance and mechanical performance. Elongation at break (Eb) is greater than or equal to 350% (preferably ≧400%) at 25° C., ≧250% (preferably ≧280%) at 150° C., and ≧150% (preferably ≧180%) at 200° C.

The fluoroelastomer compounds described above are also useful in other applications requiring dynamic fatigue resistance at high temperature, e.g. diaphragms.

### EXAMPLES

### Test Methods

Tensile properties JIS K 6251

The invention is further illustrated by, but is not limited to, the following examples.

Three different mixing techniques were employed to manufacture the comparative examples and examples of the invention:

Comparative Examples 1-3, 12-14 and Examples 1,2,4,5,7-9 and 11-17 were made in a 1.0 L Kneader internal mixer. First, fluoroelastomer was added to the mixing chamber and mixing was begun. After polymer temperature was at least 90° C., ingredients, except for curative, were added. Mixing was at a rotor speed of 50-70 rpm for several minutes. Once the compound temperature was above 150° C., the compound was dumped. A band of compound was then made on a roll mill and the curative system was added.

Comparative Examples 4, 5, 11, 15, 16 and 23 were made by making a band of fluoroelastomer on a roll mill, adding all the ingredients and mixing.

Comparative Examples 6-10, 17-22 and Examples 3, 6 and 10 were made on a 1.0 L Kneader internal mixer. First, fluoroelastomer was added to the mixing chamber and mixing was begun. After polymer temperature was at least 90° C., ingredients, except for curative, were added. Mixing was at a rotor speed of 30-50 rpm for several minutes. The rotor speed was adjusted so that the compound temperature was between 105° and 135° C. prior to dumping the mixed compound. A band of compound was then made on a roll mill and the curative system was added.

Formulations and elongation at break (Eb) are shown in the following Tables.

TABLE I

| | Comp. | Comp. | Comp. | | | Comp. | Comp. |
|---|---|---|---|---|---|---|---|
| Formulation, phr¹ | Ex. 1 | Ex. 2 | Ex. 3 | Ex. 1 | Ex. 2 | Ex. 4 | Ex. 5 |
| Fluoroelastomer 1² | 100 | 100 | 100 | 100 | 100 | 100 | 100 |
| MgO #150 | 6 | 6 | 6 | 6 | 6 | 6 | 6 |
| Ca(OH)₂ | 3 | 3 | 3 | 3 | 3 | 3 | 3 |
| MT (N-990) | 20 | | | | | | |
| SRF (N-774) | 0 | 20 | 0 | 0 | 0 | 0 | 0 |
| FEF (N-550) | 0 | 0 | 20 | 0 | 0 | 0 | 0 |
| HAF (N-330) | 0 | 0 | 0 | 20 | 0 | 20 | 0 |
| ISAF (N-220) | 0 | 0 | 0 | 0 | 20 | 0 | 20 |
| VPA-2³ | 0.5 | 0.5 | 0.5 | 0.5 | 0.5 | 0.5 | 0.5 |
| BpAF⁴ | 1.4 | 1.4 | 1.4 | 1.4 | 1.4 | 1.4 | 1.4 |
| BTPPC⁵ | 0.35 | 0.35 | 0.35 | 0.35 | 0.35 | 0.35 | 0.35 |
| N2SA of carbon black, | 9 | 29 | 42 | 83 | 119 | 83 | 119 |
| m²/g | | | | | | | |
| DBP adsorption | 43 | 72 | 121 | 102 | 114 | 102 | 114 |
| (ml/100 g) | | | | | | | |
| Mixer type for carbon | Internal | Internal | Internal | Internal | Internal | Mill | Mill |
| black mixing | | | | | | | |
| Temp, at which carbon | 100 | 102 | 105 | 104 | 106 | — | — |
| black added, ° C. | | | | | | | |
| Max. mixing temp., ° C. | 151 | 155 | 160 | 162 | 165 | — | — |
| Eb @25° C., % | 270 | 290 | 330 | 400 | 420 | 330 | 340 |
| Eb @150° C., % | 190 | 210 | 240 | 290 | 300 | 200 | 210 |
| Eb @200° C., % | 110 | 120 | 130 | 160 | 170 | 100 | 110 |

¹parts by weight ingredient per hundred parts fluoroelastomer
²Viton ® A200 available from DuPont
³Viton ® Process Aid VPA #2 available from DuPont
⁴bisphenol AF, 50% concentration in VC30 available from DuPont
⁵benzyltriphenylphosphonium chloride, 33.3% concentration in VC20

TABLE II

| | | Comp. | Comp. | | |
|---|---|---|---|---|---|
| Formulation, phr | Ex. 3 | Ex. 6 | Ex. 7 | Ex. 4 | Ex. 5 |
| Fluoroelastomer 1 | 100 | 100 | 100 | 100 | 100 |
| MgO #150 | 6 | 6 | 6 | 6 | 6 |
| Ca(OH)₂ | 3 | 3 | 3 | 3 | 3 |
| HAF (N-330) | 15 | 25 | 35 | 15 | 25 |
| VPA-2³ | 0.5 | 0.5 | 0.5 | 0.5 | 0.5 |
| BpAF⁴ | 1.4 | 1.4 | 1.4 | 1.4 | 1.4 |
| BTPPC⁵ | 0.35 | 0.35 | 0.35 | 0.35 | 0.35 |
| N2SA of carbon | 83 | 83 | 83 | 83 | 83 |
| black, m²/g | | | | | |
| DBP adsorption | 102 | 102 | 102 | 102 | 102 |
| (ml/100 g) | | | | | |
| Mixer type for | Internal | Internal | Internal | Internal | Internal |
| carbon black | | | | | |
| mixing | | | | | |
| Temp, at which | 102 | 105 | 104 | 106 | 107 |
| carbon black | | | | | |
| added, ° C. | | | | | |
| Max. mixing temp., | 127 | 129 | 135 | 158 | 166 |
| ° C. | | | | | |
| Eb @25° C., % | 460 | 370 | 270 | 440 | 350 |
| Eb @150° C., % | 310 | 240 | 180 | 320 | 250 |
| Eb @200° C., % | 160 | 120 | 90 | 180 | 150 |

TABLE III

| | Comp. | | Comp. | Comp. | Comp. | |
|---|---|---|---|---|---|---|
| Formulation, phr | Ex. 8 | Ex. 6 | Ex. 9 | Ex. 10 | Ex. 11 | Ex. 7 |
| Fluoroelastomer 1 | 100 | 100 | 100 | 100 | 100 | 100 |
| MgO #150 | 6 | 6 | 6 | 6 | 6 | 6 |
| Ca(OH)₂ | 3 | 3 | 3 | 3 | 3 | 3 |
| HAF (N-330) | 20 | 20 | 20 | 20 | 20 | 20 |
| VPA-2³ | 0.5 | 0.5 | 0.5 | 0.5 | 0.5 | 0.5 |
| BpAF⁴ | 0.6 | 1 | 1.6 | 2.4 | 1.6 | 1.6 |
| BTPPC⁵ | 0.15 | 0.25 | 0.4 | 0.6 | 0.4 | 0.4 |
| N2SA of carbon | 83 | 83 | 83 | 83 | 83 | 83 |
| black, m²/g | | | | | | |
| DBP adsorption | 102 | 102 | 102 | 102 | 102 | 102 |
| (ml/100 g) | | | | | | |
| Mixer type for | Inter- | Inter- | Inter- | Inter- | Mill | Inter- |
| carbon black | nal | nal | nal | nal | | nal |
| mixing | | | | | | |
| Temp, at which | 100 | 105 | 105 | 106 | — | 106 |
| carbon black | | | | | | |
| added, ° C. | | | | | | |
| Max. mixing | 126 | 130 | 132 | 133 | — | 165 |
| temp., ° C. | | | | | | |
| Eb @25° C., % | 520 | 470 | 370 | 250 | 290 | 350 |
| Eb @150° C., % | 190 | 270 | 250 | 170 | 180 | 250 |
| Eb @200° C., % | 110 | 150 | 130 | 80 | 90 | 150 |

TABLE IV

| | Comp. | Comp. | Comp. | | | Comp. | Comp. |
|---|---|---|---|---|---|---|---|
| Formulation, phr¹ | Ex. 12 | Ex. 13 | Ex. 14 | Ex. 8 | Ex. 9 | Ex. 15 | Ex. 16 |
| Fluoroelastomer 2⁶ | 100 | 100 | 100 | 100 | 100 | 100 | 100 |
| MgO #150 | 6 | 6 | 6 | 6 | 6 | 6 | 6 |
| MT (N-990) | 20 | | | | | | |
| SRF (N-774) | 0 | 20 | 0 | 0 | 0 | 0 | 0 |
| FEF (N-550) | 0 | 0 | 20 | 0 | 0 | 0 | 0 |
| HAF (N-330) | 0 | 0 | 0 | 20 | 0 | 20 | 0 |
| ISAF (N-220) | 0 | 0 | 0 | 0 | 20 | 0 | 20 |
| Structol HT-290⁷ | 1 | 1 | 1 | 1 | 1 | 1 | 1 |
| Peroxide⁸ | 1 | 1 | 1 | 1 | 1 | 1 | 1 |
| Coagent⁹ | 0.75 | 0.75 | 0.75 | 0.75 | 0.75 | 0.75 | 0.75 |
| N2SA of carbon | 9 | 29 | 42 | 83 | 119 | 83 | 119 |
| black, m²/g | | | | | | | |
| DBP adsorption | 43 | 72 | 121 | 102 | 114 | 102 | 114 |
| (ml/100 g) | | | | | | | |
| Mixer type for | Internal | Internal | Internal | Internal | Internal | Mill | Mill |
| carbon black mixing | | | | | | | |
| Temp, at which | 102 | 105 | 104 | 105 | 106 | — | — |
| carbon black | | | | | | | |
| added, ° C. | | | | | | | |
| Max. mixing temp., | 152 | 151 | 158 | 160 | 162 | — | — |
| ° C. | | | | | | | |
| Eb @25° C., % | 470 | 450 | 430 | 400 | 410 | 390 | 380 |
| Eb @150° C., % | 220 | 220 | 240 | 270 | 270 | 220 | 220 |
| Eb @200° C., % | 150 | 160 | 180 | 180 | 180 | 140 | 130 |

⁶Viton ® GBL200S available from DuPont
⁷process aid available from Structol
⁸Perhexa 25B40 available from Nichiyu
⁹triallyl isocyanurate available as Diak 7 from DuPont

TABLE V

| | | Comp. | Comp. | | |
|---|---|---|---|---|---|
| Formulation, phr | Ex. 10 | Ex. 17 | Ex. 18 | Ex. 11 | Ex. 12 |
| Fluoroelastomer 2 | 100 | 100 | 100 | 100 | 100 |
| MgO #150 | 6 | 6 | 6 | 6 | 6 |
| HAF (N-330) | 15 | 25 | 35 | 15 | 25 |
| Structol HT-290 | 0.5 | 0.5 | 0.5 | 0.5 | 0.5 |
| Peroxide⁸ | 1.4 | 1.4 | 1.4 | 1.4 | 1.4 |
| Coagent⁹ | 0.35 | 0.35 | 0.35 | 0.35 | 0.35 |
| N2SA of carbon black, | 83 | 83 | 83 | 83 | 83 |
| m²/g | | | | | |
| DBP adsorption | 102 | 102 | 102 | 102 | 102 |
| (ml/100 g) | | | | | |
| Mixer type for carbon | Internal | Internal | Internal | Internal | Internal |
| black mixing | | | | | |
| Temp, at which carbon | 102 | 105 | 106 | 101 | 104 |
| black added, ° C. | | | | | |
| Max. mixing temp., ° C. | 128 | 130 | 132 | 152 | 161 |
| Eb @25° C., % | 460 | 380 | 250 | 440 | 360 |
| Eb @150° C., % | 290 | 240 | 150 | 290 | 250 |
| Eb @200° C., % | 180 | 150 | 100 | 200 | 160 |

TABLE VI

| | Comp. | Comp | Comp. | Comp. | Comp. | |
|---|---|---|---|---|---|---|
| Formulation, phr | Ex. 19 | Ex. 20 | Ex. 21 | Ex. 22 | Ex. 23 | Ex. 13 |
| Fluoroelastomer 2 | 100 | 100 | 100 | 100 | 100 | 100 |
| MgO #150 | 6 | 6 | 6 | 6 | 6 | 6 |
| HAF (N-330) | 20 | 20 | 20 | 20 | 20 | 20 |
| Structol HT-290 | 1 | 1 | 1 | 1 | 1 | 1 |
| Peroxide⁸ | 1 | 1 | 1 | 1 | 1 | 1 |
| Coagent⁹ | 0.2 | 0.5 | 1 | 2 | 0.5 | 0.5 |
| N2SA of carbon | 83 | 83 | 83 | 83 | 83 | 83 |
| black, m²/g | | | | | | |
| DBP adsorption | 102 | 102 | 102 | 102 | 102 | 102 |
| (ml/100 g) | | | | | | |
| Mixer type for | Inter- | Inter- | Inter- | Inter- | Mill | Inter- |
| carbon black | nal | nal | nal | nal | | nal |
| mixing | | | | | | |
| Temp, at which | 98 | 102 | 100 | 105 | — | 105 |
| carbon black | | | | | | |
| added, ° C. | | | | | | |
| Max. mixing | 127 | 130 | 131 | 135 | — | 155 |
| temp., ° C. | | | | | | |
| Eb @25° C., % | 630 | 450 | 370 | 260 | 440 | 430 |
| Eb @150° C., % | 220 | 250 | 240 | 160 | 230 | 260 |
| Eb @200° C., % | 150 | 140 | 140 | 100 | 140 | 170 |

TABLE VII

| Formulation, phr | Ex. 14 | Ex. 15 | Ex. 16 | Ex. 17 |
|---|---|---|---|---|
| Fluoroelastomer 2 | 100 | 100 | 100 | 100 |
| Ca(OH)₂¹⁰ | 3 | — | 3 | — |
| DBU¹¹ | — | 1.5 | — | 1.5 |
| HAF (N-330) | 20 | 20 | — | — |
| ISAF (N-220) | — | — | 20 | 20 |
| Structol HT-290 | 1 | 1 | 1 | 1 |
| Peroxide⁸ | 1 | 1 | 1 | 1 |
| Coagent⁹ | 0.5 | 0.5 | 0.5 | 0.5 |
| N2SA of carbon black, | 83 | 83 | 119 | 119 |
| m²/g | | | | |
| DBP adsorption | 102 | 102 | 114 | 114 |
| (ml/100 g) | | | | |
| Mixer type for carbon | Internal | Internal | Internal | Internal |
| black mixing | | | | |
| Temp, at which carbon | 103 | 101 | 105 | 106 |
| black added, ° C. | | | | |
| Max. mixing temp., ° C. | 155 | 156 | 156 | 155 |
| Eb @25° C., % | 460 | 450 | 440 | 460 |
| Eb @150° C., % | 280 | 270 | 270 | 280 |
| Eb @200° C., % | 180 | 180 | 180 | 180 |

¹⁰available as Calvit from Ohmi Chemical
¹¹salt of 1,8-diazabicyclo[5.4.0]undec-7-ene available as DA-500 from Daiso Co. Ltd.

What is claimed is:

1. A cured fluoroelastomer hot air hose comprising:
(A) fluoroelastomer having at least 53 weight percent fluorine, said fluoroelastomer comprising copolymerized units of vinylidene fluoride and at least one copolymerizable monomer;
(B) 10 to 30 parts by weight, per hundred parts by weight fluoroelastomer, of carbon black having a nitrogen adsorption specific surface area of 70-150 m²/g and a dibutyl phthalate absorption of 90-180 ml/100 g;
(C) 0.8 to 1.8 parts by weight, per hundred parts by weight fluoroelastomer, of a polyol curative; and
(D) 0.2 to 1 parts by weight, per hundred parts by weight fluoroelastomer, of a cure accelerator.

2. The fluoroelastomer air hose of claim 1 wherein said carbon black is selected from the group consisting of ASTM N330, ASTM N220 and ASTM N110.

3. The fluoroelastomer air hose of claim 2 wherein said carbon black is ASTM N330.

4. The fluoroelastomer air hose of claim 1 wherein said air hose has an elongation at break of at least 350% at 25° C. and an elongation at break of at least 150% at 200° C.

5. A cured fluoroelastomer hot air hose comprising:
(A) fluoroelastomer having at least 53 weight percent fluorine, said fluoroelastomer comprising copolymerized units of vinylidene fluoride and at least one copolymerizable monomer;
(B) 10 to 30 parts by weight, per hundred parts by weight fluoroelastomer, of carbon black having a nitrogen adsorption specific surface area of 70-150 m²/g and a dibutyl phthalate absorption of 90-180 ml/100 g;
(C) 0.25 to 2 parts by weight, per hundred parts by weight fluoroelastomer, of organic peroxide; and
(D) 0.3 to 1.3 parts by weight, per hundred parts by weight fluoroelastomer, of a multifunctional coagent.

6. The fluoroelastomer air hose of claim 5 wherein said carbon black is selected from the group consisting of ASTM N330, ASTM N220 and ASTM N110.

7. The fluoroelastomer air hose of claim 6 wherein said carbon black is ASTM N330.

8. The fluoroelastomer air hose of claim 5 wherein said air hose has an elongation at break of at least 350% at 25° C. and an elongation at break of at least 150% at 200° C.
